(19) United States
(12) Patent Application Publication
(10) Pub. No.: US 2008/0173808 A1
(43) Pub. Date: Jul. 24, 2008

(54) PROCESS AND DEVICE FOR RESPONSE NORMALIZED LIQUID CHROMATOGRAPHY NANOSPRAY IONIZATION MASS SPECTROMETRY (RNLC-NSI-MS)

(75) Inventors: Ragulan Ramanathan, Kendall Park, NJ (US); Swapan K. Chowdhury, Warren, NJ (US); Kevin B. Alton, Cedar Knolls, NJ (US)

Correspondence Address: SCHERING-PLOUGH CORPORATION;PATENT DEPARTMENT (K-6-1, 1990), 2000 GALLOPING HILL ROAD, KENILWORTH, NJ, 07033-0530, US

(73) Assignee: Schering Corporation

(21) Appl. No.: 12/015,953

(22) Filed: Jan. 17, 2008

Related U.S. Application Data
(60) Provisional application No. 60/885,484, filed on Jan. 18, 2007.

(51) Int. Cl. H01J 49/26

(52) U.S. Cl. 250/282; 250/288

(57) ABSTRACT

Disclosed are a process and a device for the detection, identification, and quantification of chemical compounds or biomolecules using Response Normalized Liquid Chromatography NanoSpray Ionization Mass Spectrometry (RNLC-NSI-MS).

This Application claims the benefit of U.S. Provisional Application Ser. No. 60/885484, filed Jan. 18, 2007, which is incorporated herein by reference in its entirety.

### FIELD OF THE INVENTION

The present invention relates to a process for the detection, identification, and quantification of chemical compounds (e.g., organic compounds or compounds having a MW less than 1000) or biomolecules (e.g., peptides, nucleic acids) resulting from biotransformation or degradation of a parent chemical compound or parent biomolecule, or wherein said chemical compounds or biomolecules are present as impurities formed in the pharmaceutical formulation of said parent chemical compound or parent biomolecule, without the necessity of preparing radiolabeled parent chemical compound or parent biomolecule, or without the use of other reference standards, utilizing a Response Normalized Liquid Chromatography NanoSpray Ionization Mass Sprectrometry (RNLC-NSI-MS).

The present invention also relates to a Liquid Chromatography Mass Spectrometry (LC-MS) system comprising components for carrying out said RNLC-NSI-MS.

### BACKGROUND OF THE INVENTION

LC-MS techniques using Electrospray Ionization (ESI) and Atmospheric Pressure Chemical Ionization (APCI) have been extensively used (1-8) for the detention and identification of pharmaceuticals, drug metabolites and synthetic organic compounds. However, widely different LC-MS response for different classes of compounds limited the use of LC-MS in full scan detection mode for quantitative determination of pharmaceuticals and metabolites. For quantitative assessment, validated or qualified LC-MS/MS methods in selected reaction monitoring or multiple reaction monitoring modes with appropriate internal standard for each analyte of interest is generally used and is limited to one or two analytes in each assay. However, in drug metabolism studies a number of new chemical entities result from biotransformation of a single drug and are detected in a single LC-MS run. No internal standard for metabolites, certified and in sufficient quantities, are generally available at the time of metabolite characterization for mounting LC-MS/MS assays for their quantitation. Therefore, drug metabolism studies are conducted with radiolabeled drugs and the metabolite levels are determined from the radioactivity content within each LC peak in flow scintillation analysis. However, radiolabeled compounds are usually not available in early stage of drug discovery and for administration to humans in early clinical development.

Recent introduction of nanospray ionization (10, 11) technique has some promise in achieving close MS response for some compounds but not for many others (see for example, reference (16)).

There is a need for a process to achieve more uniform LC-MS response for drugs and metabolites (compounds of different structural classes, in general). The present invention provides such a process. The process involves a nanospray LC-MS technique that gives comparable LC-MS response for most metabolites and the parent drug that we have evaluated.

### REFERENCES

[1] Watt, A. P.; Mortishire-Smith, R. J.; Gerhard, U. and Thomas, S. R. (2003) Curr. Opin. Drug Discov. Devel., 6(1), 57-65.
[2] Clarke, N. J.; Rindgen, D.; Korfmacher, W. A. and Cox, K. A. (2001) Anal. Chem., 73(15), 430A-439A.
[3] Kostiainen R.; Kotiaho, T.; Kuuranne, T. and Auriola, S. (2003) J. Mass Spectrom., 38(4), 357-372.
[4] Nassar, A. E. and Talaat, R. E. (2004) Drug Discov. Today, 9(7), 317-327.
[5] Dole, M.; Mack, L. L.; Hines, R. L.; Mobley, R. C.; Ferguson, L. D. and Alice, M. B. (1968) J. Chem. Phys., 49(5), 2240-2249.
[6] Whitehouse, C. M.; Dreyer, R. N.; Yamashita, M. and Fenn, J. B. (1985) Anal. Chem., 57(3), 675-679.
[7] Yamashita, M. and Fenn, J. B. (1984) J. Phys. Chem., 88(20), 4451-4459.
[8] Yamaguchi, K. and Fenn, J. B. (1984) J. Phys. Chem., 88(20), 4671-4675.
[9] Wilm, M. S. and Mann, M. (1996), Anal. Chem., 68, 1-8.
[10] Schultz, G. A.; Corso, T. N.; Prosser, S. J.; and Zhang, S. (2000) Anal. Chem., 72, 4058-4063.
[11] Kebarle, P. and Ho, Y. (1997) in Electrospray Ionization Mass Spectrometry: Fundamentals, Instrumentation, and Applications, (Cole, R. B. Ed.), Wiley-Interscience, New York, pp. 1-63.
[12] Ramanathan, R.; Su, A. D.; Alvarez, N.; Blumenkrantz, N.; Chowdhury, S. K.; Alton, K. and Patrick, J. (2000) Anal. Chem., 72(6), 1352-1359.
[13] Ramanathan, R.; Alvarez, N.; Su, A. D.; Chowdhury, S.; Alton, K.; Stauber, K. and Patrick, J. (2005) Xenobiotica, 35(2), 155-189.
[14] Gorecki, T.; Lynen, F.; Szucs, R.; and Sandra, P. (2006) Anal. Chem., 78(9), 3186-3192.
[15] Dixon, R. W.; and Peterson, D. S. (2002) Anal. Chem., 74(13), 2930-2937.
[16] Valaskovic, G. A.; Utley, L.; Lee, M. L.; and Wu, J-T. (2006) Rapid Commun. Mass Spectrom., 20,1087-1096.
[17] Hop, Cornelis E. C. A. (2006) Curr. Drug Metabolism, 7, 557-563

### SUMMARY OF THE INVENTION

In its many embodiments, the invention provides a process for the detection, identification, and quantification of chemical compounds or biomolecules resulting from biotransformation or degradation of a parent chemical compound or parent biomolecule, or wherein said chemical compounds or biomolecules are present as impurities formed in the pharmaceutical formulation of said parent chemical compound or parent biomolecule, without the necessity of preparing radiolabeled parent chemical compound or parent biomolecule, or without the use of other reference standards, said process comprising utilizing a Response Normalized Liquid Chromatography NanoSpray Ionization Mass Sprectrometry (RNLC-NSI-MS), wherein said RNLC-NSI-MS comprises the steps of: (i) passing a mixture said chemical compounds or biomolecules optionally with said parent chemical compound or parent biomolecule, through an HPLC system comprising an aqueous mobile phase, an organic mobile phase and a column containing a stationary phase effective for the separation of said mixture of chemical compounds or biomolecules, optionally with said parent chemical compounds or biomolecules, (ii) adding to all or a portion of the HPLC column effluent a response normalizing flow effluent, wherein said response normalizing flow effluent provides a gradient of mobile phase that is inverse to that passing through the HPLC column, (iii) passing a portion of the combined response normalized effluent (HPLC column effluent plus the added response normalizing flow effluent) through a nanospray ionization source for MS analysis, and (iv) detecting the presence and relative amounts of the chemical compounds or biomolecules via the MS detector.

In another embodiment, the present invention provides a Liquid Chromatography Mass Spectrometry (LC-MS) system for the detection, identification, and quantification of chemical compounds or biomolecules resulting from biotransformation or degradation of a parent chemical compound or parent biomolecule, or wherein said chemical compounds or biomolecules are present as impurities formed in the pharmaceutical formulation of said parent chemical compound or parent biomolecule, without the necessity of preparing radiolabeled parent chemical compound or parent biomolecule, or without the use of other reference standards, comprising: (a) an analytical HPLC (High Performance Liquid Chromatomagrahy) system comprising an aqueous mobile phase, an organic mobile phase and a column containing a stationary phase effective for the separation of a mixture of chemical compounds or biomolecules optionally with said parent chemical compound or parent biomolcule, (b) a response normalizing HPLC which provides a normalizing flow effluent comprising a gradient of mobile phase that is inverse to that provided by the analytical HPLC (a), and (c) a MS (Mass Spectrometer) comprising a (i) nanospray ionization source for producing ions, and (ii) a detector for detecting ions produced by the nanospray ionization source.

### DESCRIPTION OF THE DRAWINGS

FIG. 1 is a schematic of the Experimental Set-Up for Response Normalized Liquid Chromatography Nanospray Ionization Mass Spectrometry (RNLC-NSI-MS).

FIG. 2 is a Comparison of LC-MS responses obtained using conventional flow LC-ESI-MS, RNLC-NSI-MS and radioactivity detection for Vircriviroc and its Metabolites.

FIG. 3 shows the Structures of Vicriviroc and its Metabolites that were evaluated using NRLC-NSI-MS.

FIG. 4 is a Comparison of LC-MS responses obtained using conventional flow LC-ESI-MS, RNLC-NSI-MS and radioactivity detection for Desloratadine and its Metabolites.

FIG. 5 shows the Structures of Desloratadine and its Metabolites that were evaluated using NRLC-NSI-MS.

FIG. 6 shows LC-MS spectra of tolbutamide and hydroxy-tolbutamide obtained with (top panel) and without (bottom panel) response normalizing (RN) HPLC flow.

FIG. 7 shows LC-MS spectra of cocaine and benzoylecgonine obtained with (top panel) and without (bottom panel) response normalizing (RN) HPLC flow.

### DETAILED DESCRIPTION OF THE INVENTION

The terms used herein have their ordinary meaning and the meaning of such terms is independent at each occurrence thereof. That notwithstanding and except where stated otherwise, the following definitions apply throughout the specification and claims.

As used above, and throughout the specification, the following terms, unless otherwise indicated, shall be understood to have the following meanings:

“Chemical compound(s)” has the meaning as understood by one of ordinary skill in the art. In one embodiment, such compounds have a molecular weight (MW) less than 1000. In another embodiment, they are organic compounds.

“Biomolecule” refers biological molecules including peptides, and nuclei acids (such as DNA, RNA), and proteins.

The chemical compounds and biomolecules include compounds and molecules in the form of salts (including pharmaceutically acceptable salts) or solvates.

The term “salt(s)”, as employed herein, denotes acidic salts formed with inorganic and/or organic acids, as well as basic salts formed with inorganic and/or organic bases. In addition, when a chemical compound or biomolecule contains both a basic moiety, such as, but not limited to a pyridine or imidazole, and an acidic moiety, such as, but not limited to a carboxylic acid, zwitterions (“inner salts”) may be formed and are included within the term “salt(s)” as used herein. Pharmaceutically acceptable (i.e., non-toxic, physiologically acceptable) salts are preferred, although other salts are also useful. Salts of the chemical compound or biomolecule may be formed, for example, by reacting the free chemical compound or biomolecule with an amount of acid or base, such as an equivalent amount, in a medium such as one in which the salt precipitates or in an aqueous medium followed by lyophilization.

Exemplary acid addition salts include acetates, ascorbates, benzoates, benzenesulfonates, bisulfates, borates, butyrates, citrates, camphorates, camphorsulfonates, fumarates, hydrochlorides, hydrobromides, hydroiodides, lactates, maleates, methanesulfonates, naphthalenesulfonates, nitrates, oxalates, phosphates, propionates, salicylates, succinates, sulfates, tartarates, thiocyanates, toluenesulfonates (also known as tosylates,) and the like. Additionally, acids which are generally considered suitable for the formation of pharmaceutically useful salts from basic pharmaceutical compounds are discussed, for example, by P. Stahl et al, Camille G. (eds.) Handbook of Pharmaceutical Salts. Properties, Selection and Use. (2002) Zurich: Wiley-VCH; S. Berge et al, Journal of Pharmaceutical Sciences (1977) 66(1) 1-19; P. Gould, International J. of Pharmaceutics (1986) 33 201-217; Anderson et al, The Practice of Medicinal Chemistry (1996), Academic Press, New York; and in The Orange Book (Food & Drug Administration, Washington, D.C. on their website). These disclosures are incorporated herein by reference thereto.

Exemplary basic salts include ammonium salts, alkali metal salts such as sodium, lithium, and potassium salts, alkaline earth metal salts such as calcium and magnesium salts, salts with organic bases (for example, organic amines) such as dicyclohexylamines, t-butyl amines, and salts with amino acids such as arginine, lysine and the like. Basic nitrogen-containing groups may be quarternized with agents such as lower alkyl halides (e.g. methyl, ethyl, and butyl chlorides, bromides and iodides), dialkyl sulfates (e.g. dimethyl, diethyl, and dibutyl sulfates), long chain halides (e.g. decyl, lauryl, and stearyl chlorides, bromides and iodides), aralkyl halides (e.g. benzyl and phenethyl bromides), and others.

All such acid salts and base salts are intended to be pharmaceutically acceptable salts within the scope of the invention and all acid and base salts are considered equivalent to the free forms of the corresponding compounds for purposes of the invention.

One or more chemical compounds or biomolecules may exist in unsolvated as well as solvated forms with pharmaceutically acceptable solvents such as water, ethanol, and the like, and it is intended that the invention embrace both solvated and unsolvated forms. “Solvate” means a physical association of a chemical compound or biomolecule of this invention with one or more solvent molecules. This physical association involves varying degrees of ionic and covalent bonding, including hydrogen bonding. In certain instances, the solvate will be capable of isolation, for example when one or more solvent molecules are incorporated in the crystal lattice of the crystalline solid. “Solvate” encompasses both solution-phase and isolatable solvates. Non-limiting examples of suitable solvates include ethanolates, methanolates, and the like. “Hydrate” is a solvate wherein the solvent molecule is H₂O.

In one embodiment, the chemical compound of the invention has a molecular weight (MW) less than 1000.

In another embodiment, the chemical compound of the invention is an organic compound.

In another embodiment, the biomolecule of the invention is a peptide, protein, or a nucleic acid (e.g., DNA, RNA).

In another embodiment, the process of the present invention is for the detection, identification and quantification of chemical compounds.

In another embodiment, the chemical compounds resulting from biotransformation of parent chemical compound are metabolites of the parent chemical compound.

In another embodiment, the degradation that produces said chemical compounds or biomolecules is the result of subjecting said parent chemical compound or parent biomolecule to ultraviolet (UV) light, or treatment with an acid or base (e.g., acid or base hydrolysis).

In another embodiment, the degradation occurs as a result of storage.

In another embodiment, the process of the present invention is for the detection, identification, and quantification of chemical compounds or biomolecules that are present as impurities formed in the pharmaceutical formulation of said parent chemical compound or parent biomolecule.

In another embodiment of the presently claimed process, the response normalizing flow effluent is added to only a portion of the HPLC column effluent, and the remaining portion of the HPLC column effluent is diverted to an auxiliary detector, or to a different device or chemical instrument.

In another embodiment, the aforementioned auxiliary detector is a radioactivity detector, charged aerosol detector, UV detector, or fluorescent detector.

In another embodiment, the aforementioned device or chemical instrument is selected from the group consisting of a fraction collector, a nuclear magnetic resonance (NMR) spectrometer, or a mass spectrometer.

In another embodiment, the response normalizing flow effluent in the present invention is added to only about 10-30% of the HPLC column effluent, and the remaining 70-90% of the column effluent is diverted to an auxiliary detector, or to a different device or chemical instrument.

In another embodiment, the response normalizing flow effluent in the present invention is added to only about 15-25% of the HPLC column effluent, and the remaining 75-85% of the column effluent is diverted to an auxiliary detector.

In another embodiment, in the presently claimed process, step (iii) of RNLC-NSI-MS comprises passing about 0.5% to about 5% of the combined response normalized effluent through the nanospray ionization source for MS analysis, and the remainder of the combined normalized effluent is passed through to waste, a fraction collector, or to a different device or chemical instrument.

In another embodiment, step (iii) of RNLC-NSI-MS comprises passing about 0.5% to about 5% of the combined response normalized effluent through the nanospray ionization source for MS analysis, and the remainder of the combined response normalized effluent is passed through to waste or a fraction collector.

In another embodiment of the present invention, step (iii) of RNLC-NSI-MS comprises passing about 1% of the combined response normalized effluent through the nanospray ionization source for MS analysis, and the remainder of the combined effluent is passed through to a fraction collector or to waste.

In another embodiment of the present invention, the aqueous mobile phase of step (i) of said RNLC-NSI-MS comprises a solution of about 10 mM ammonium acetate (pH 6.0) containing about 5% acetonitrile (v/v).

In another embodiment of the present invention, the organic mobile phase of step (i) of said RNLC-NSI-MS comprises a solution of about 95% acetonitrile and 5% water (v/v).

In another embodiment of the present invention, the chemical compounds detected, identified and quantified are tolbutamide and hydroxy-tolbutamide.

In another embodiment of the present invention, the chemical compounds detected, identified and quantified are selected from the group consisting of:

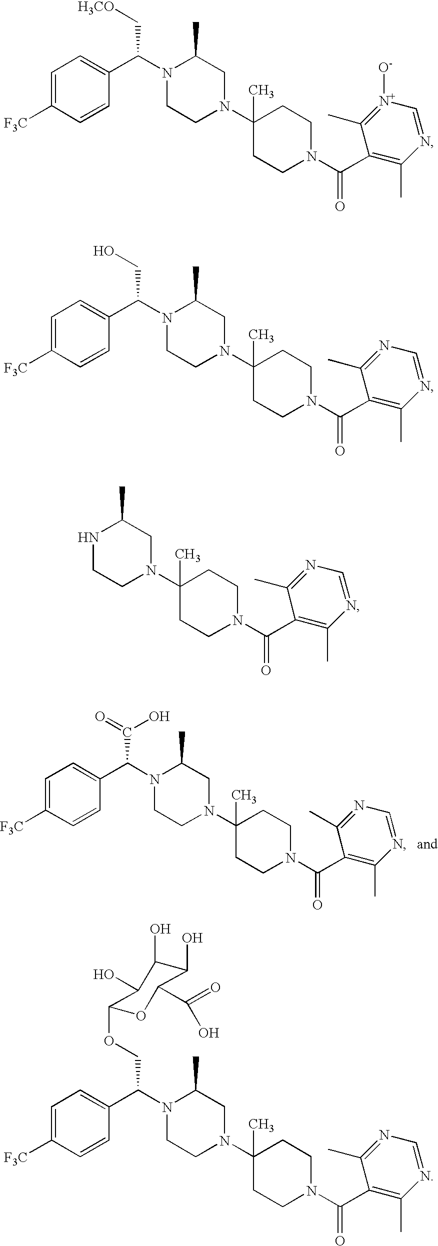

In another embodiment of the present invention, the chemical compounds detected, identified and quantified are selected from the group consisting of:

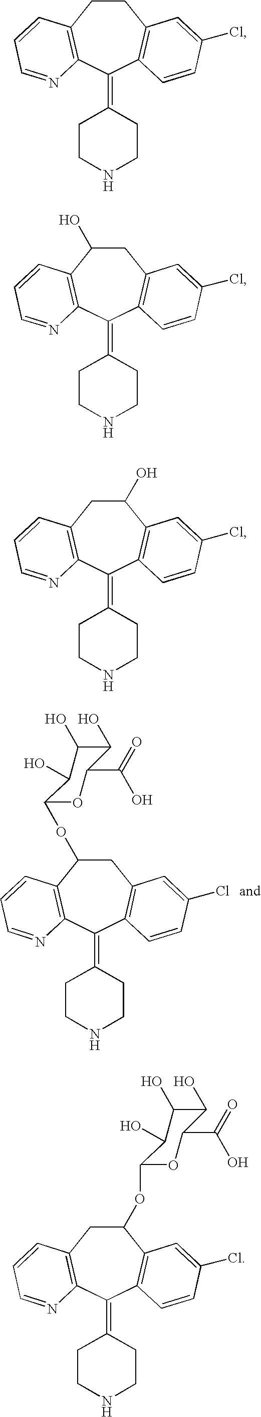

In another embodiment of the present invention, the chemical compounds detected, identified and quantified are selected from the group consisting of cocaine and benzoylecgonine (O-desmethyl-cocaine) having the structures set forth below:

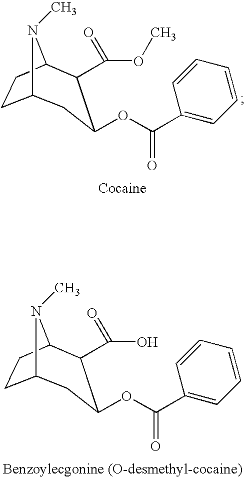

### EXAMPLES

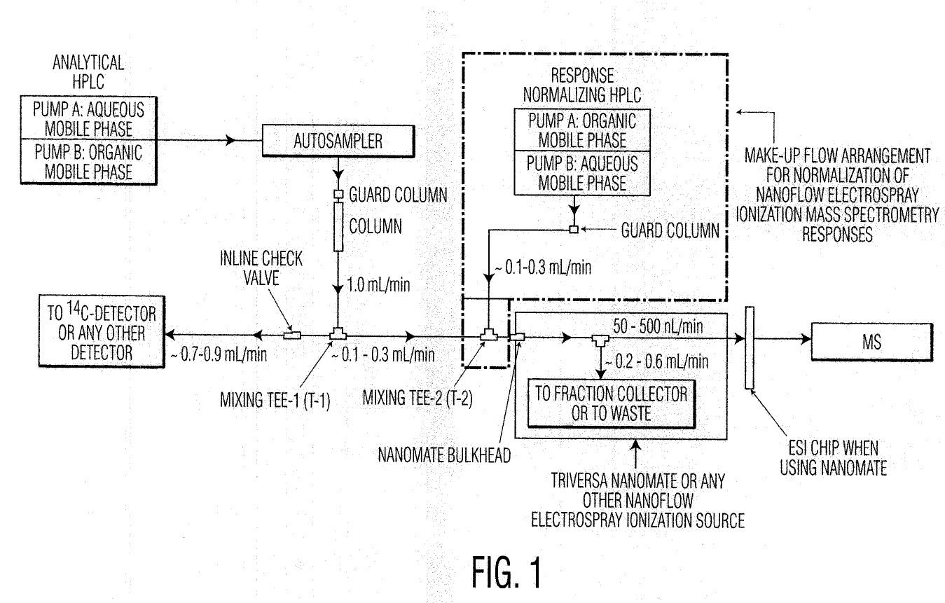

The experimental set-up used for achieving a response normalized liquid chromatography (RNLC) nanospray ionization (NSI) mass spectrometry (MS) is shown in FIG. 1.

For experiments described herein, high performance liquid chromatography (HPLC) separations of analytes were performed at room temperature using the first HPLC system referred to in FIG. 1 as “analytical HPLC”. The mobile phase, which consisted of 10 mM ammonium acetate (pH 6.0) containing 5% acetonitrile (v/v) (aqueous mobile phase, pump A) and 95% acetonitrile and 5% water (v/v) (organic mobile phase, pump B), was maintained at a constant flow rate of 1 mL/min. Any mobile phase combinations and any flow rate suitable for a given assay can be used with appropriate flow split. The analytical HPLC column effluent was split (mixing tee 1 or T-1 in FIG. 1) so that 15-25% of the flow was directed to a second mixing tee (T-2 in FIG. 1) connected to the NSI source and 75-85% diverted to an auxiliary detector (e.g. a radioactivity detector (10-11) or a charged aerosol detector (12-13)). Separation of metabolites was achieved using the analytical HPLC system and programmed linear changes in mobile phase composition as shown in Table 1.

TABLE 1

| | | Response Normalized Liquid |
|---|---|---|
| | | Chromatography Nanospray |
| | | Ionization Mass Spectrometry |
| Instrument/Parameters | Conventional LC-ESI-MS | (RNLC-NSI-MS) |
| Mass Spectrometer | TSQ Quantum | Q-TOF Global (Waters Corp., |
| | (ThermoElectron Corp., San | Milford, MA) |
| | Jose, CA) | |
| Ion Source Inlet | API source (ThermoElectron | TriVersa Nanomate (Advion |
| | Corp., San Jose, CA) | BioSciences, Ithaca, NY) |
| Ionization Mode | Positive | Positive |
| Spray Voltage (kV) | 4.2 | 1.7-1.9 |
| Analytical HPLC | Waters Alliance 2695 (Waters | Shimadzu (Shimadzu |
| | Corp., Milford, MA) | Corporation, Kyoto, Japan) |
| Analytical HPLC | Waters Alliance 2695 (Waters | Waters Alliance 2695 (Waters |
| | Corp., Milford, MA) | Corp., Milford, MA) |
| Column | Phenomenex Luna Phenyl- | Phenomenex Luna Phenyl- |
| | Hexyl, 4.6 × 250 mm | Hexyl, 4.6 × 250 mm |
| | (Phenomenex, Inc., Torrance, | (Phenomenex, Inc., Torrance, |
| | CA) | CA) |
| Analytical HPLC flow (mL/min) | 1.0 | 1.0 |
| Guard Column | MetaGuard 4.6 mm Polaris | MetaGuard 4.6 mm Polaris |
| | C18-A, 5-μm particle size | C18-A, 5-μm particle size |
| | (Varian Inc., Lake Forest, CA) | (Varian Inc., Lake Forest, CA) |
| Response Normalizing HPLC | 0.15 | 0.05-0.20 |
| flow (mL/min) | | |
| HPLC flow into MS | 0.2 mL/min | 200-500 nL/min |
| Aqueous Mobile Phase | 10 mM ammonium acetate | 10 mM ammonium acetate |
| | (pH 6.0) containing 5% | (pH 6.0) containing 5% |
| | acetonitrile, (v/v) | acetonitrile, (v/v) |
| Organic Mobile Phase | 95% acetonitrile and 5% water | 95% acetonitrile and 5% water |
| | (v/v) | (v/v) |
| Radioactivity Detector | Model C525F00 flow | Model C525F00 flow |
| | scintillation analyzer (FSA) | scintillation analyzer (FSA) |
| | (PerkinElmer Life and | (PerkinElmer Life and |
| | Analytical Sciences, Inc., | Analytical Sciences, Inc., |
| | Boston, MA). | Boston, MA). |
| Radioactivity Detector Flow | 250 μL (PerkinElmer Life & | 250 μL (PerkinElmer Life & |
| Cell | Analytical Sciences) | Analytical Sciences) |
| Scintillation Cocktail | Flo-Scint III ™ | PerkinElmer Life & Analytical |
| | | Sciences (Boston, MA) |

Gradient Method Used for RNLC-NSI-MS
of Human and Monkey Urine

| Time (min) | % A | % B |
|---|---|---|
| 0 | 90 | 10 |
| 10 | 70 | 30 |
| 40 | 30 | 70 |
| 40.1 | 10 | 90 |
| 50 | 10 | 90 |
| 50.1 | 90 | 10 |
| 60 | 90 | 10 |

Gradient Method Used for Equimolar Mixture of RNLC-NSI-MS
of Tolbutamide and Hydroxytolbutamide

| Time (min) | % A | % B |
|---|---|---|
| 0 | 98 | 2 |
| 15 | 10 | 90 |
| 15.1 | 98 | 2 |
| 20 | 98 | 2 |

A second HPLC pump, referred to in FIG. 1 as the “Response Normalizing HPLC”, was used to deliver an exactly inverse gradient. Inverse gradient was achieved by switching the aqueous mobile phase to pump B and the organic mobile phase to pump A and using the same gradient program as the one used in the analytical HPLC system. The flow rate of the Response Normalizing HPLC system was maintained between 0.1 and 0.2 mL/min. However, in practice, any flow rate suitable for an assay can be used. The “Response Normalizing Flow” was introduced into the NSI source via a second mixing tee (T-2). HPLC flows from the analytical HPLC and from the “Response Normalizing HPLC” were combined in the second mixing tee (T-2). The combined flow was delivered to the NSI (NanoMate, API, or any other ion sources) via a union (referred in FIG. 1 as “bulkhead”). For NSI experiments, the combined flow is further split using a mixing tee. The split ratio within the NSI source was manipulated by adjusting the various diameters and lengths of fused silica capillary tubing used to deliver the flow to MS and the fraction collector/waste. Approximately 1-5% of the combined flow was delivered to the NSI source for MS analysis.

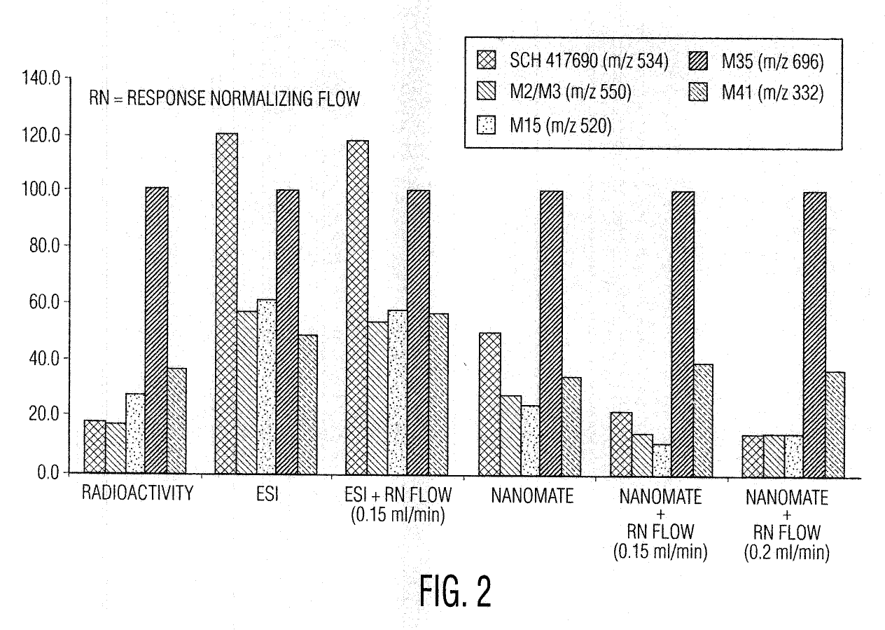

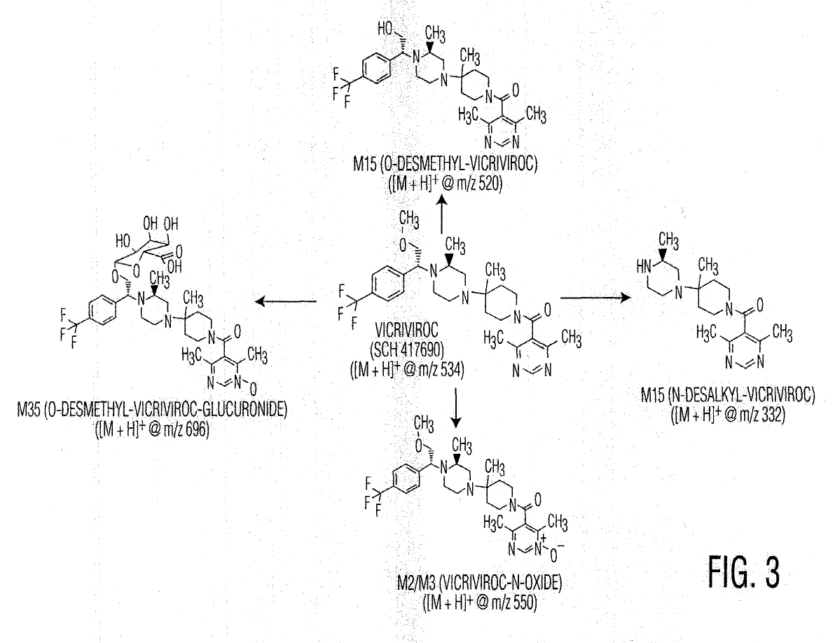

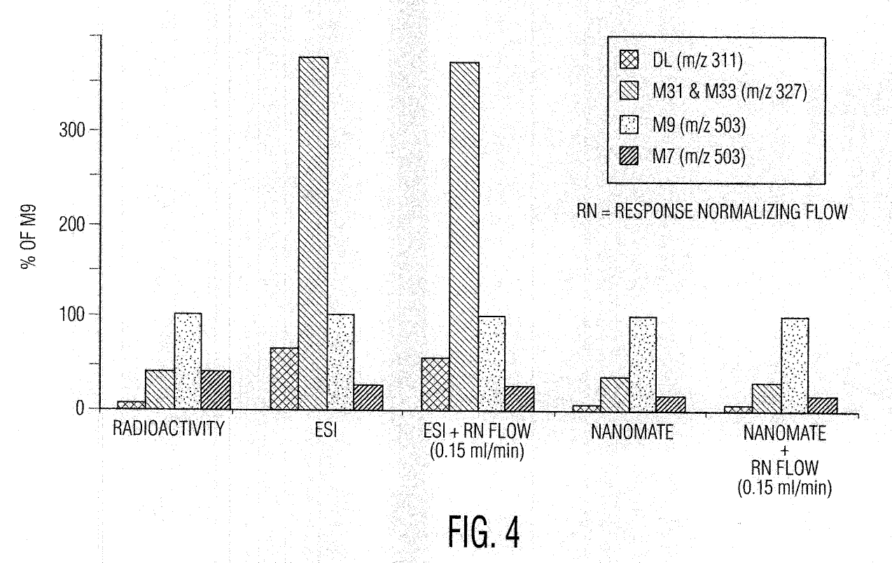

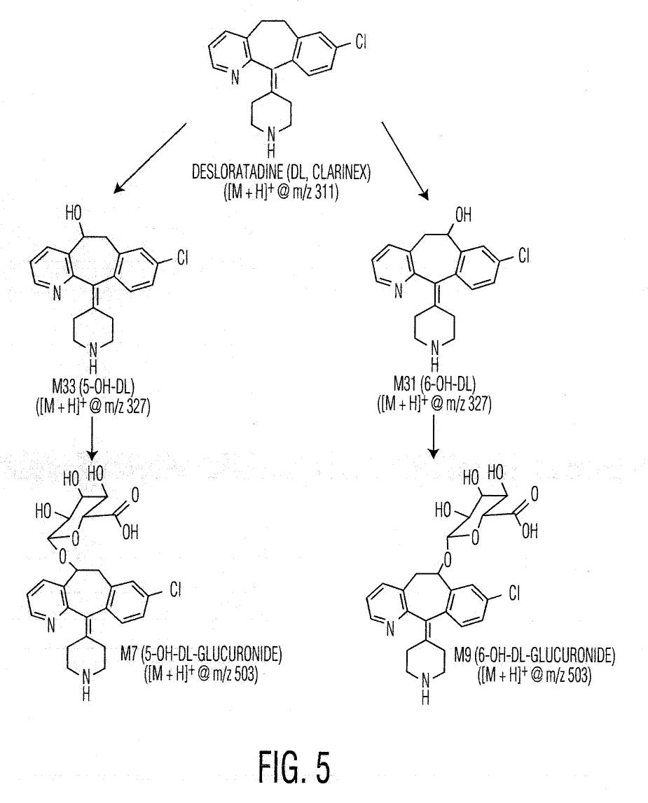

FIGS. 2, 4 and 6 show examples of data collected using the response normalized liquid chromatography nanospray ionization-MS (RNLC-NSI-MS) system depicted in FIG. 1). FIG. 2 compares LC-MS responses of Vicriviroc (SCH 417690) and its metabolites, M2/M3,,M15, M35, and M41 (structures shown in FIG. 3) obtained using NSI-MS with that obtained using radioactivity detector and LC-ESI-MS. Table 2 below shows a comparison of the results of conventional flow LC-ESI-MS and Nano flow LC-ESI-MS for Vicriviroc and its metabolites by listing the actual responses. Clearly, the addition of the “Response Normalizing” flow normalizes the NSI-MS responses of Vicriviroc and its metabolites to match closely to that of the radioactivity detector. A radioactivity detector is nondiscriminatory with respect to different molecular weights and different molecular structures and is immune to most effects of matrices. Similarly, FIG. 4 compares LC-MS responses of Desloratadine and its metabolites, M33, M31, M7, and M9 (structures shown in FIG. 5). Table 3 below shows a comparison of the results of conventional flow LC-ESI-MS and Nano flow LC-ESI-MS for Desloratadine and its metabolites by listing the actual responses. Again, the addition of the “Response Normalizing” flow normalizes the NSI-MS responses of Desloratadine and its metabolites to match fairly closely to that of the radioactivity detector.

TABLE 2
Comparison of Conventional Flow LC-ESI-MS and Nano
Flow LC-ESI-MS for Vicriviroc and its Metabolites

| | | Conventional Flow | | Nanoflow | | |
|---|---|---|---|---|---|---|
| | | ESI (TSQ Quantum) | | ESI (NanoMate-QTOF) | | |
| Drug/ | | | 0.15 | | 0.15 | 0.2 |
| Metabolites | | Without | mL/min | Without | mL/min | mL/min |
| (mass-to- | | Normalizing | Normalizing | Normalizing | Normalizing | Normalizing |
| charge | | HPLC | HPLC | HPLC | HPLC | HPLC |
| ratio) | Radioactivity | flow | flow | flow | flow | flow |
| Vicriviroc | 17.2 | 120 | 118 | 50.0 | 23.0 | 14.3 |
| (m/z 534) | | | | | | |
| M2/M3 | 16.8 | 56.9 | 53.3 | 27.8 | 14.6 | 14.3 |
| (m/z 550) | | | | | | |
| M15 | 26.8 | 60.8 | 57.4 | 24.3 | 11.9 | 14.3 |
| (m/z 520) | | | | | | |
| M35 | 100 | 100 | 100 | 100 | 100 | 100 |
| (m/z 696) | | | | | | |
| M41 | 35.9 | 48.7 | 56.2 | 34.0 | 39.7 | 37.1 |
| (m/z 332) | | | | | | |

TABLE 3
Comparison of Conventional Flow LC-ESI-MS and Nano Flow
LC-ESI-MS for Desloratadine and its Metabolites

| | | Conventional Flow | | Nanoflow | |
|---|---|---|---|---|---|
| Drug/ | | ESI (TSQ Quantum) | | ESI (NanoMate-QTOF) | |
| Metabolites | | | 0.15 | | 0.15 |
| (mass-to- | | Without | mL/min | Without | mL/min |
| charge | | Normalizing | Normalizing | Normalizing | Normalizing |
| ratio) | Radioactivity | HPLC flow | HPLC flow | HPLC flow | HPLC flow |
| DL (m/z | 2.63 | 61.5 | 50.8 | 5.0 | 2.52 |
| 311) | | | | | |
| M31&M33 | 37.0 | 378 | 371.2 | 33.1 | 26.6 |
| (m/z 327) | | | | | |
| M9 | 100 | 100 | 100 | 100.0 | 100 |
| (m/z 503) | | | | | |
| M7 | 38.2 | 23.9 | 23.4 | 13.4 | 14.8 |
| (m/z 503) | | | | | |

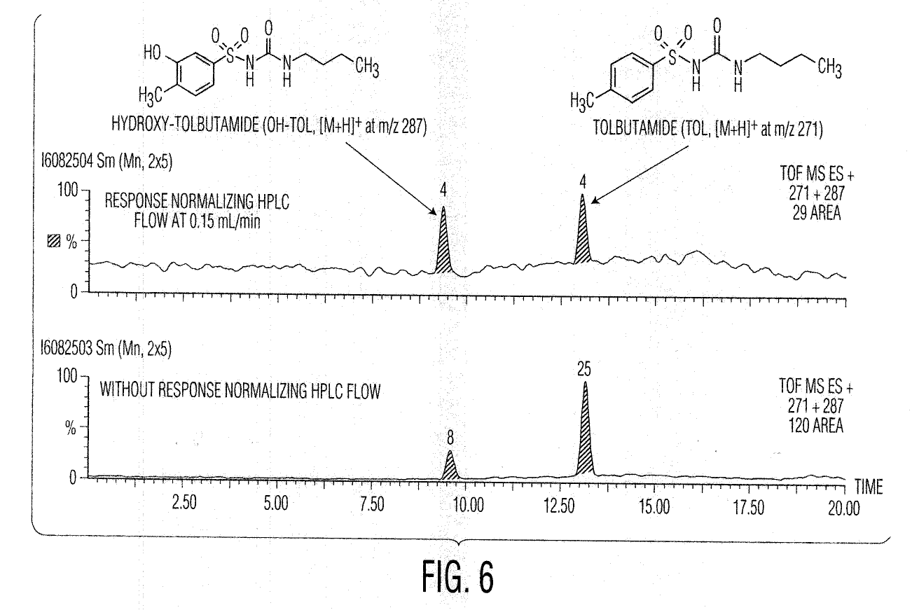

As an unequivocal demonstration of the normalized response for an equimolar mixture (0.5 Mole injected) of tolbutamide (TOL) and hydroxy-tolbutamide (OH-TOL) is shown in FIG. 6 using the RNLC-NSI-MS system shown in FIG. 1. As shown in FIG. 6, without the use of the “response Normalization” flow, equimolar mixtures of TOL and OH-TOL gave integrated LC-MS responses in the ratio of 25 and 8, respectively. Upon utilization of the inverse gradient response normalization flow (0.15 mL/min), equimolar mixture of TOL and OH-TOL gave equal LC-MS responses.

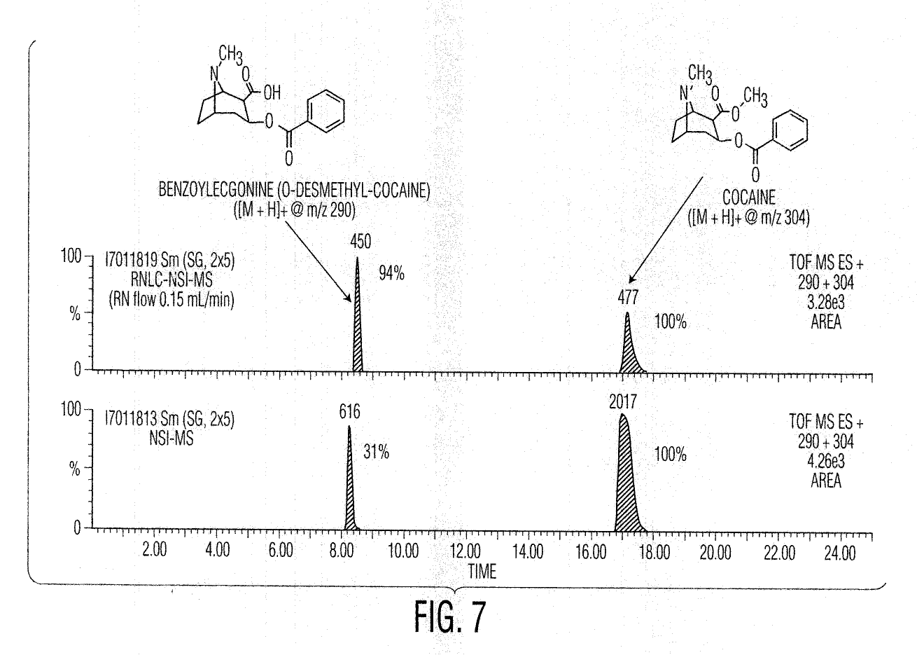

FIG. 7 demonstrates the normalized response for an equimolar mixture (20 mM mixture; 25 μL injected0 of cocaine and benzoylecgonine (O-desmethyl-cocaine) using the RNLC-NSI-MS system shown in FIG. 1. As shown in FIG. 7, without the use of the “response Normalization” flow, equimolar mixtures of benzoylecgonine and cocaine gave integrated LC-MS responses in the ratio of 616 and 2017 respectively. Upon utilization of the inverse gradient response normalization flow (0.15 mL/min), equimolar mixture of benzoylecgonine and cocaine gave almost equal LC-MS responses.

By combining exactly inverse gradients in T-2, the mobile composition delivered to the electrospray ionization source is normalized through out the gradient program. Most likely, normalization of the gradient results in the normalization of the ion suppression and/or ion enhancement. The normalization effect is more pronounced under NSI conditions because smaller initial droplets are produced form the ionization source and smaller droplets benefits from increased total available surface area, decreased diffusion time for an analyte to the surface, and reduced number of columbic explosion prior to ion formation (see Ref. 16). These effects collectively help to normalize LC-MS response of drugs and metabolites under gradient conditions used for metabolite profiling experiments. Thus, allowing quantitative assessment of metabolites without the use of radiolabelled parent drug or LC-MSIMS based quantitative assays.

While the present invention has been described in conjunction with the specific embodiments set forth above, many alternatives, modifications and variations thereof will be apparent to those of ordinary skill in the art. All such alternatives, medications and variations are intended to fall within the spirit and scope of the present invention.

Each of every reference document cited herein is incorporated by reference for all purposes.

What is claimed is:

1. A process for the detection, identification, and quantification of chemical compounds or biomolecules resulting from biotransformation or degradation of a parent chemical compound or parent biomolecule, or wherein said chemical compounds or biomolecules are present as impurities formed in the pharmaceutical formulation of said parent chemical compound or parent biomolecule, without the necessity of preparing radiolabeled parent chemical compound or parent biomolecule, or without the use of other reference standards, said process comprising utilizing a Response Normalized Liquid Chromatography NanoSpray Ionization Mass Sprectrometry (RNLC-NSI-MS), wherein said RNLC-NSI-MS comprises the steps of: (i) passing a mixture said chemical compounds or biomolecules optionally with said parent chemical compound or parent biomolecule, through an HPLC system comprising an aqueous mobile phase, an organic mobile phase and a column containing a stationary phase effective for the separation of said mixture of chemical compounds or biomolecules, optionally with said parent chemical compounds or biomolecules, (ii) adding to all or a portion of the HPLC column effluent a response normalizing flow effluent, wherein said response normalizing flow effluent provides a gradient of mobile phase that is inverse to that passing through the HPLC column, (iii) passing a portion of the combined response normalized effluent (HPLC column effluent plus the added response normalizing flow effluent) through a nanospray ionization source for MS analysis, and (iv) detecting the presence and relative amounts of the chemical compounds or biomolecules via the MS detector.

2. The process of claim 1, wherein said chemical compound has a molecular weight (MW) less than 1000.

3. The process of claim 1, wherein said chemical compound is an organic compound.

4. The process of claim 1, wherein said biomolecule is a peptide, protein, or a nucleic acid.

5. The process of claim 1, wherein said process is for the detection, identification and quantification of chemical compounds.

6. The process of claim 1, wherein the chemical compounds resulting from biotransformation of the parent chemical compound are metabolites of the parent chemical compound.

7. The process of claim 1, wherein said degradation is the result of subjecting said parent chemical compound or parent biomolecule to ultraviolet (UV) light, or treatment with an acid or base.

8. The process of claim 1, wherein said degradation occurs as a result of storage.

9. The process of claim 1, wherein said process is for the detection, identification, and quantification of chemical compounds or biomolecules that are present as impurities formed in the pharmaceutical formulation of said parent chemical compound or parent biomolecule.

10. The process of claim 1, wherein the response normalizing flow effluent is added to only a portion of the HPLC column effluent, and the remaining portion of the HPLC column effluent is diverted to an auxiliary detector, or to a different device or chemical instrument.

11. The process of claim 10, wherein the auxiliary detector is a radioactivity detector, charged aerosol detector, UV detector, or fluorescent detector.

12. The process of claim 10, wherein said device or chemical instrument is selected from the group consisting of a fraction collector, a nuclear magnetic resonance (NMR) spectrometer, or a mass spectrometer.

13. The process of claim 10, wherein the response normalizing flow effluent is added to only about 10-30% of the HPLC column effluent, and the remaining 70-90% of the column effluent is diverted to an auxiliary detector, or to a different device or chemical instrument.

14. The process of claim 13, wherein the response normalizing flow effluent is added to only about 15-25% of the HPLC column effluent, and the remaining 75-85% of the column effluentiis diverted to an auxiliary detector.

15. The process of claim 1, wherein step (iii) of RNLC-NSI-MS comprises passing about 0.5% to about 5% of the combined response normalized effluent through the nanospray ionization source for MS analysis, and the remainder of the combined response normalized effluent is passed through to waste, a fraction collector, or to a different device or chemical instrument.

16. The process of claim 13, wherein the remainder of the combined response normalized effluent is passed through to waste or a fraction collector.

17. The process of claim 13, wherein step (iii) of RNLC-NSI-MS comprises passing about 1% of the combined response normalized effluent through the nanospray ionization source for MS analysis, and the remainder of the combined response normalized effluent is passed through to a fraction collector or to waste.

18. The process of claim 1, wherein the aqueous mobile phase of step (i) of said RNLC-NSI-MS comprises a solution of about 10 mM ammonium acetate (pH 6.0) containing about 5% acetonitrile (v/v).

19. The process of claim 1, wherein the organic mobile phase of step (i) of said RNLC-NSI-MS comprises a solution of about 95% acetonitrile and 5% water (v/v).

20. The process of claim 3, wherein the chemical compounds are tolbutamide and hydroxy-tolbutamide.

21. The process of claim 3, wherein the chemical compounds are selected from the group consisting of:

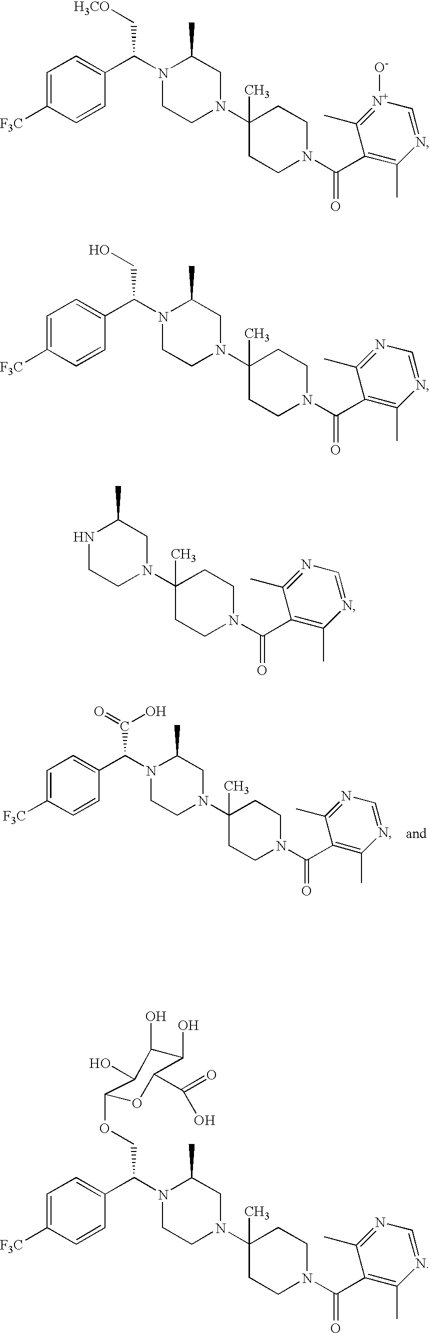

22. The process of claim 3, wherein the chemical compounds are selected from the group consisting of:

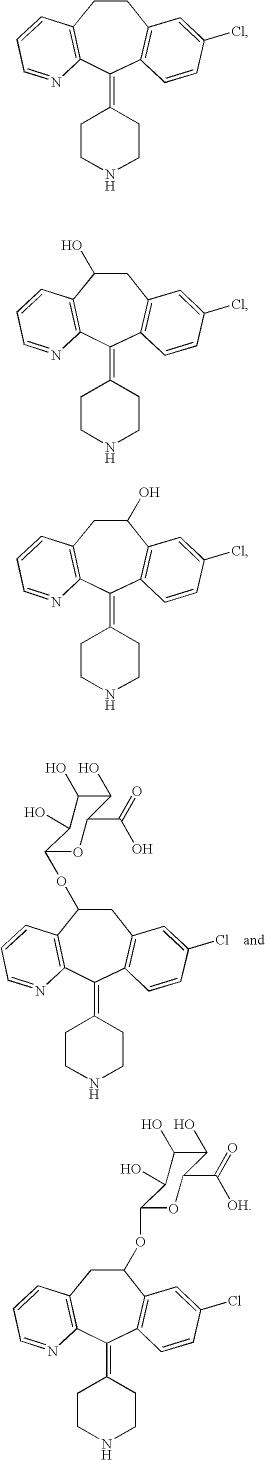

23. The process of claim 3, wherein the chemical compound is selected from the group consisting of cocaine and benzoylecgonine (O-desmethyl-cocaine).

24. A Liquid Chromatography Mass Spectrometry (LC-MS) system for the detection, identification, and quantification of chemical compounds or biomolecules resulting from biotransformation or degradation of a parent chemical compound or parent biomolecule, or wherein said chemical compounds or biomolecules are present as impurities formed in the pharmaceutical formulation of said parent chemical compound or parent biomolecule, without the necessity of preparing radiolabeled parent chemical compound or parent biomolecule, or without the use of other reference standards, comprising: (a) an analytical HPLC (High Performance Liquid Chromatomagrahy) system comprising an aqueous mobile phase, an organic mobile phase and a column containing a stationary phase effective for the separation of a mixture of chemical compounds or biomolecules optionally with said parent chemical compound or parent biomolcule, (b) a response normalizing HPLC which provides a normalizing flow effluent comprising a gradient of mobile phase that is inverse to that provided by the analytical HPLC (a), and (c) a MS (Mass Spectrometer) comprising a (i) nanospray ionization source for producing ions, and (ii) a detector for detecting ions produced by the nanospray ionization source.
